(19) United States
(12) Patent Application Publication
(10) Pub. No.: US 2012/0290340 A1
(43) Pub. Date: Nov. 15, 2012

(54) METHOD, SYSTEM, AND APPARATUS FOR FACILITATING CONCURRENT PURCHASE OF ANY COMBINATION OF TICKETS, CONCESSIONS AND MERCHANDIZE FOR ENTERTAINMENT AND SPORTING EVENTS LEVERAGING WEB, MOBILE DEVICES AND SOCIAL MEDIA TOOLS

(76) Inventors: SRINIVASAN RAMANUJAM, Santa Crus, CA (US); Devendra Joshi, San Jose, CA (US)

(21) Appl. No.: 13/489,889

(22) Filed: Jun. 6, 2012

Related U.S. Application Data
(63) Continuation-in-part of application No. 13/214,075, filed on Aug. 19, 2011.
(60) Provisional application No. 61/384,307, filed on Sep. 19, 2010.
(60) Provisional application No. 61/496,334, filed on Jun. 13, 2011.

(51) Int. Cl. G06Q 10/02

(52) U.S. Cl. 705/5

(57) ABSTRACT

The preferred embodiment of the present invention is directed to a method, system and apparatus to automate the sale and purchase of entertainment tickets along with concessions and/or merchandize, individually or as a package, in the electronic media comprising web, mobile apps and social media channels.

### RELATED APPLICATIONS

This application is a continuation-in-part utility patent application of a U.S. provisional patent application entitled, “Method, System and Apparatus for Facilitating Concurrent Purchase of Any Combination of Tickets, Concessions and Merchandize for Entertainment and Sporting Events Leveraging Web, Mobile Devices and Social Media Tools”, by Srinivasan Ramanujam and Devendra Joshi, filed on Jun. 13, 2011 and assigned U.S. patent application Ser. No. 61/496,334, which application is a continuation-in-part utility patent application of a U.S. non provisional patent application entitled, “Method, System and Apparatus for Facilitating Automated Real-Time Negotiating and Bargaining Followed by Purchase of Merchandize,” by Srinivasan Ramanujam and Devendra Joshi, filed on Aug. 19, 2011 and assigned U.S. patent application Ser. No. 13/214,075, which application is a continuation-in-part patent application of now expired U.S. provisional patent application entitled, “Method, System and Apparatus for Facilitating Automated Real-Time Negotiating and Bargaining Followed by Purchase of Merchandize,” by Srinivasan Ramanujam and Devendra Joshi, filed on Sep. 19, 2010 and assigned U.S. patent application Ser. No. 61/384,307.

### BACKGROUND

The present invention is in the general field of automating sales and purchase of entertainment event tickets bundled together with food concessions as well as entertainment souvenirs and related merchandize using web and mobile applications and through the use of social networking tools. More particularly, the present invention is in the technical field of electronic automation enabling consumers to conveniently purchase desired event tickets along with any food concessions and other merchandize by themselves or as a package using any of the electronic devices including mobile/smart phones, tablets or i-Pad or similar devices, net books and other mobile computing devices, desktop, laptop and other computing devices, or telephones.

Event tickets for all major forms of entertainment, such as movies, concerts, sporting events, theme parks etc., can be bought in advance or just before show time, using either internet web sites or via mobile apps (together called e- and m-commerce). Food concessions including drinks, snacks, food, etc. are part of the “total enjoyment” of any entertainment and concessions (a list from which consumers can select what they want) are not generally offered to consumers by themselves or as a packaged combination when they buy tickets in advance. In a likewise manner, merchandize such as Tee-shirts, caps, gifts, memorabilia, etc. are not offered in advance of the event either. Imagine a rock-concert where today one can only buy tickets but not any concert memorabilia or tee-shirts or other items concurrently.

To highlight this situation further, for example, the North American Cinema ticket business for 2010 was about $10.5 B (MPAA, 2011) with about 1.4 B tickets sold. It's estimated that movie concessions alone could be in the range of $4-$5B/year in revenue to movie exhibitors. Movie tickets are offered on sale through the web today (ex: fandango, movietickets.com); however sales of concessions—such as popcorn and soft drinks, is an afterthought—to be bought at the busy concession counter at the movie theater after entering it. They are not properly marketed in advance to movie goers. Same is the case with any movie merchandize as theaters are afraid to inventory these items.

Often entertainment events are not sold out. Movie halls, for example, usually have a lot of empty seats especially after the opening week, except in the case of select mega hit movies. In situations like this, vendors should be able to appropriately discount movie tickets and offer to the consumers attractive deals or discounts. Combining this with, for example food concessions at competitive prices, is even a better idea on slower days to get additional revenue. Entertainment-goers today do not have an option to get discounted tickets packaged appropriately with the desired concessions and/or merchandize nor can they actively negotiate the purchase price.

The market for social commerce (using Facebook, twitter, MySpace, etc.) is still embryonic but is expected to change over the next 5 years, becoming a huge sales channel (Booze and Co, 2011). Globally, internet users spend over 4.5 hours per week on social sites. Chances are that when consumers are in a social site, if they desire to engage in any buying, they would rather do it within the social media site and consummate the purchase. Social media offers an attractive channel for vendors to sell tickets packaged appropriately with the desired concessions and/or merchandize.

The power of social media is such that the local venues (such as a local movie theater or a playhouse or local concert hall) could have their own social media pages (such as in FaceBook or MySpace or YouTube) but could have all their local content be funneled in from a global-site that contains comprehensive information of all entertainment events but also have fun elements such as games and gossip. This addresses the problem of letting the local pages go stale.

Tools, solutions and options offered by the prior art (Kalaboukis, Pub # US 2008/0154739 A1; Hillerbrand et al., Pub # US 2010/0262477 A1; Swart et al., Pub US# 2002/009539 A1; Keronen et al., Pub # US 2010/0063892 A1; Sussman et al., Patent # U.S. Pat. No. 7,865,379 B2; Showghi et al, Patent # U.S. Pat. No. 6.920,431 B2; Diamond et al., Pub # US 2006/0161474 A1; Wilder, U.S. Pat. No. 5,408,417; Eglen et al., Patent # U.S. Pat. No. 7,587,372 B2; Kobayashi et al., Patent # U.S. Pat. No. 7,093,130 B1, Smith Patent # U.S. Pat. No. 7,194,418 B2; Lamber et al., Pub # US 2007/0088616 A1; Eglen et al., Pub # US 2010/0241492 A1; Bret, U.S. Pat. No. 7,647,269 82; Kim, Pub # US 2006/0178930 A1; Sunshine et al., Pub # US 2009/0216571 A1; Deas et al., U.S. Pat. No. 7,346549 B2; Charania et al., Pub # US 2010/0082374 A1) do not specifically address how to carry out the commerce of tickets, concessions and merchandise sale individually or as a package either on the web or via social media channels.

### BRIEF SUMMARY OF THE INVENTION

The preferred embodiment of the present invention is directed to a method, system and apparatus to automate the sale and purchase of entertainment tickets along with concessions and/or merchandize, individually or as a package, in the electronic media comprising web, mobile apps and social media channels.

The tools offered here can not only enable buyers to buy entertainment tickets and concessions and/or merchandize as selected specifically by the buyer but also enable the buyers to negotiate and consummate the purchase, in an automated manner, the best deal they could get from the vendors.

More particularly, in one preferred method, using various entertainment and recreational venues including but not limited to movie theaters, sporting events, concert halls, theatrical events, theme parks, and their corresponding commercial entities (collectively known as “vendor”), which can offer entrance tickets, concessions, including food, alcoholic and non-alcoholic beverages, candies and others, and entertainment merchandize including gifts, souvenirs, tee-shirts, caps and others, individually or as a package, (collectively known as tickets and merchandize”), the method comprises the steps of: (1) vendor hosting of a special site on the web or a mobile app to present to consumers various such offers for tickets and merchandize; (2) customers accessing the web to access such offer using a plurality of electronic devices, including but not limited to desktop computers, laptops, net books, tablets; and (3) using a plurality of connectivity including but not limited to wired or wireless internet connection or downloading an app in a mobile device including but not limited to mobile phones, smart phones, portable computers, net books, tablets, and using a plurality of connectivity including but not limited to wireless, WiFi, Internet connectivity, to access such offer at the mobile app location; (4) selecting a desired combination of event tickets and merchandize; (5) completing the payment and executing the transaction via secured connectivity; and (6) obtaining a plurality of codes, including but not limited to one time use only bar codes, letters or numbers or combination, or printing a voucher or getting an appropriate bar-code on the mobile devices to be shown at the vendor's entrance or box office counter, in exchange for the tickets and merchandize.

In a preferred embodiment a system and apparatus to facilitate detailed display of entertainment events and venues that user can access with an electronic device, selection at least one offering for sale by a corresponding commercial entity at an . accessed entertainment venue, initialization of payment transaction process in response to a step of selecting, execution of the payment transaction process via secured connectivity, and receive at least one completed transaction code to be shown at said at least one entertainment venue to facilitate an exchange of the at least one completed transaction code in response to the step of selecting at least one offering for sale by said corresponding commercial entity, the system generally comprises (1) means for using a plurality of electronic devices, including but not limited to desktop computers, laptops, net books, tablets and using a plurality of connectivity including but not limited to wired or wireless internet connection means for using a plurality of mobile electronic devices including but not limited to mobile phones, smart phones, portable computers, net books, tablets, and using a plurality of connectivity including but not limited to wireless, WiFi, Internet connectivity; (2)means for accessing and connecting the electronic devices using the UI to a Point of Sale system; (3) means for identifying, selecting and confirming at least one offering for sale by a corresponding commercial entity at an accessed entertainment venue; (4) means for initiating a payment transaction process in response to said step of selecting; (5) means for executing the payment transaction process via secured connectivity; and (6) means for obtaining at least one completed transaction code to be shown at said at least one entertainment venue to facilitate an exchange of the at least one completed transaction code in response to the step of selecting at least one offering for sale by said corresponding commercial entity.

In another preferred method of vending the method comprises the steps of (1) hosting a user accessible domain; (2) providing a user with an electronic accessible domain to access at least one entertainment venue; (3) selecting at least one offering for sale that's a combination of two or more venue items; (4) initiating a payment transaction process in response to said step of selecting; (5) executing the payment transaction process via secured connectivity; and (6) obtaining at least one completed transaction code to be shown at said at least one entertainment venue to facilitate an exchange of the at least one completed transaction code in response to the step of selecting at least one offering for sale by said corresponding commercial entity.

In this second preferred method, the at least one entertainment venue is selected from a group of entertainment venues including: a recreational venues, a sporting event venue, a theme park venue, a movie theater venue, a music event venue, and a theatrical event venue.

In the second preferred method the two or more venue items include any combination of the following: an entrance ticket, a concession item including: a prepared food item, an alcoholic beverage, a non-alcoholic beverage, a candy item, and a snack food item, and an entertainment merchandizing item including: a gift, a souvenir, a tee-shirt, a cap, a sports wear item, and a clothing item;

Also in the second preferred method the two or more venue items are for sale by a corresponding commercial entity at an accessed entertainment venue.

In the second preferred method the two or more venue items include a gift package item comprising: combinations of said entrance tickets, concession items and said merchandizing items.

Still yet in the second preferred method the user accessible domain includes computer accessible websites and mobile device communication applications.

Further in the second preferred method the computer accessible websites may be accessed using a plurality of electronic devices, including: desktop computers, laptop computers, net books, electronic communication tablets.

In the second preferred method the step of providing said user with an electronic accessible domain includes the step of (1) using a plurality of connectivity including: a wired internet connection, a wireless internet connection, downloading a software application into at least one mobile device using at least one of a plurality of connectivity including: wireless connectivity, Wi-Fi connectivity, and internet connectivity, to access said at least one entertainment venue at the mobile app location.

Also in the second preferred method the at least one mobile device includes: a mobile phone device, a smart phone device, a portable computer, a net book, an electronic tablets.

Still yet In the second preferred method the step of obtaining at least one completed transaction code includes the step of (1) receiving at least one of a plurality of codes including a one time use only bar codes, a one time use letter, a one time use number or a combination of bar codes, letters, and numbers for a one time use.

Further in the second preferred method, the step of obtaining at least one completed transaction code includes (1) printing a voucher or getting an appropriate bar-code on a mobile device; and wherein the voucher or the bar-code may be displayed at said at least one entertainment to further facilitate the exchange of the at least one completed transaction code in exchange for tickets and merchandize.

In the second preferred method the step of initiating includes (1) enabling the user to present an offer price for a user selected offering through a sequence of one or more interactions with a bidding server; (2) entering said offer price for the user selected offering; (3) responding to the user with a vendor acceptable price; (4) declining the vendor acceptable price; (5) entering another offer price in response to the declined vendor acceptable price; and (6) repeating said steps of responding, declining and entering until either the bidding server declines a further offer price in response to the declined vendor acceptable price or the user enters an acceptance of the vendor acceptable price.

Also in the second preferred method, the step of executing the payment transaction process via secured connectivity includes completing a payment of the accepted vendor acceptable price.

Still yet in the second preferred method the step of hosting a user accessible domain includes hosting a specialized social media site; and wherein the specialized social media site includes social media sites accessible on the web or via a mobile software application to facilitate presenting the user with a ticket and merchandizing offer sponsored by said specialized social media site.

Further in the second preferred method the steps of providing, selecting, initiating, executing, and obtaining are all consummated without the user leaving said specialized social media site.

In the second preferred method wherein the user at any time initiates invitation to user's, select contacts whose names are either stored in the specialized social media site or manually input to join the user to purchase the same ticket and merchandizing offer sponsored by said specialized social media site.

Also in the second preferred method wherein the vendor can electronically communicate separately with the user at any time prior or after the said entertainment event to offer additional related or unrelated merchandize including trinkets, toys, souvenirs, pictures, art work, memorabilia, dolls, clothing, shoes, make up items, for sale.

Still yet in a third preferred method there is provided a method of hosting a user accessible domain which includes the step of (1) hosting a specialized social media site; and wherein the specialized social media site includes social media sites accessible on the web or via a mobile software application; and wherein said specialized social media site includes social media sites that are geographically local to user and social media sites that are geographically un-restrained and are global; (2) storing all relevant entertainment information on a global basis at a single global social media site; and (3) providing all relevant information necessary for the functionality of geographically local social media site from the above global social media site.

In still yet another preferred embodiment there is provided a system for vending a combination of two or more venue items. The preferred system generally comprises (1) means for hosting a user accessible domain; (2) means for providing said user with an electronic accessible domain to access at least one entertainment venue; (3) means for selecting at least one offering for sale that's a combination of two or more venue items; (4) means for initiating a payment transaction process in response to said step of selecting; (5) means for executing the payment transaction process via secured connectivity; and (6) means for obtaining at least one completed transaction code to be shown at said at least one entertainment venue to facilitate an exchange of the at least one completed transaction code in response to the step of selecting at least one offering for sale by said corresponding commercial entity.

### BRIEF DESCRIPTION OF THE DRAWINGS

The above mentioned features and steps of the invention and the manner of attaining them will become apparent, and the invention itself will be best understood by reference to the following description of the preferred embodiment(s) of the invention in conjunction with the accompanying drawings wherein:

FIG. 1 is a diagrammatic illustration of a method of vending ticket bundles;

FIG. 2 is a flow chart of the method of vending ticket bundles as described relative to FIG. 1;

FIG. 3 is an diagrammatic illustration of a typical purchase receipt issued after completion of a ticket bundle purchase;

FIG. 4 is multiple implementation interfaces enabling a customer to use multiple devices to use the method of vending ticket bundles as described relative to FIG. 1;

FIG. 5 illustrates local and global application allowing a customer/user to purchase a ticket bundle from a specific entertainment venue or to search from a global application; and

FIG. 6 is a diagrammatic illustration of invite friends for the same entertainment event before or after purchasing a ticket bundle.

### DETAILED DESCRIPTION OF THE PREFERRED EMBODIMENTS

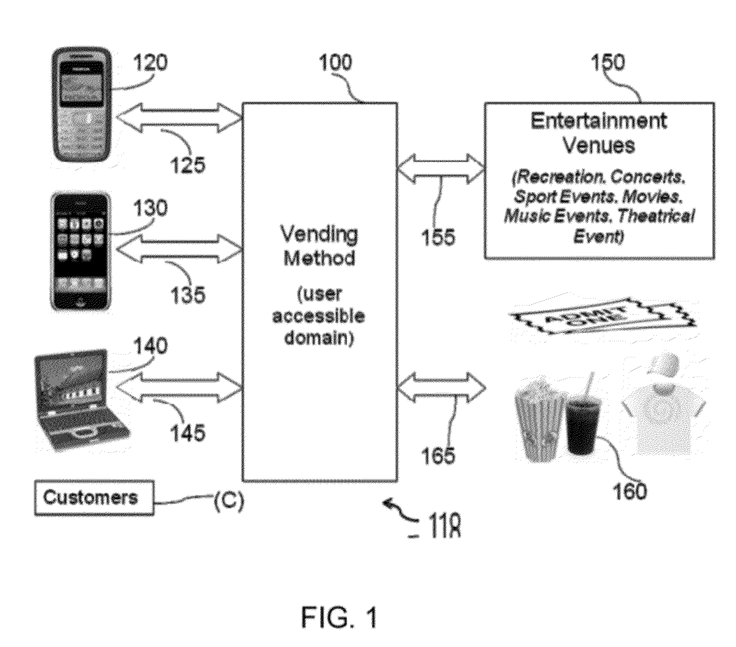

Referring now to the invention in more detail, FIG. 1 illustrates the method of vending, system and computer program hosted by user accessible domain, enabling the customer to select at least one entertainment venue and entertainment event, then purchase ticket bundle including, but not limited to, event tickets for entrance, concessions and entertainment merchandizing items. The event selection includes the event name and time.

The concession includes food items, non-alcoholic beverages, alcoholic beverages, candies, snacks, and prepared food items. The entertainment merchandizing items include gifts, souveniers, tee-shirts, caps, sports wear, and clothing item for sale, toys, books, stationary, bags, etc. Hereafter the combined sale will be referred as ticket bundle sale. The ticket bundle sale can happen together as one combined sale or else can happen separately at different time and in any order.

In this invention the method of vending is developed, as shown in FIG. 1, to enable the customer to use multitude of devices to access the vending method, hosted in user accessible domain, select at least one entertainment venue and purchase event's ticket bundle.

In one embodiment 110, a customer (C) is provided with a method to access the system in real time using multitudes of devices, including but not limited to, normal phones 120 with text messaging service, smart phones 130 with internet access and systems 140 like laptops, netbooks, tablets, personal computers etc with internet access.

Further in this embodiment 110 the customers using normal phones 120 with text service will use SMS (short message service), as shown at 125, to communicate with system 100 for selecting at least one entertainment venue and purchase event's ticket bundle.

Further in this embodiment 110 the customers using smart phones 130 with internet data service will use website or smart phone application, as shown at 135, to communicate with system 100 for selecting at least one entertainment venue and purchase event's ticket bundle. This communication is done by XML (extension markup language) queries and results.

Further in this embodiment 110 the customers using systems 140 like laptops, netbooks, tablets, personal computers etc with internet access will use website or software application, as shown at 145, to communicate with system 100 for selecting at least one entertainment venue and purchase event's ticket bundle. This communication is done by XML (extension markup language) queries and results.

In this embodiment 110 the customer can select the entertainment venue by specifying the location address, city or zip code, then select the entertainment event from list of events based on text or image or multimedia description and then buy the ticket bundle. The system 100 will process this information to uniquely identify the customer selection and complete the purchase transaction.

Further in this embodiment 110 the method integrates with entertainment venues 150 who hosts or manage entertainment events, including but not limited to, can be concerts, sports, movie theatres, amusement parks, etc. The system 100 will communicate with entertainment venues 150 as shown generally at 155 to get regular update about events and ticket bundles. The system 100 will integrate with deployed “Point of Sale” system, and supporting infrastructure of entertainment venues 150 to access the ticket bundle information and execute the purchase transaction.

Further in this embodiment 110 the system 100 will define the ticket bundles 160, show them to customer and allow the customer to select and buy the ticket bundle as indicated at 165. Once the customer 110 completes the purchase the sale information will also be communicated to entertainment venues 150.

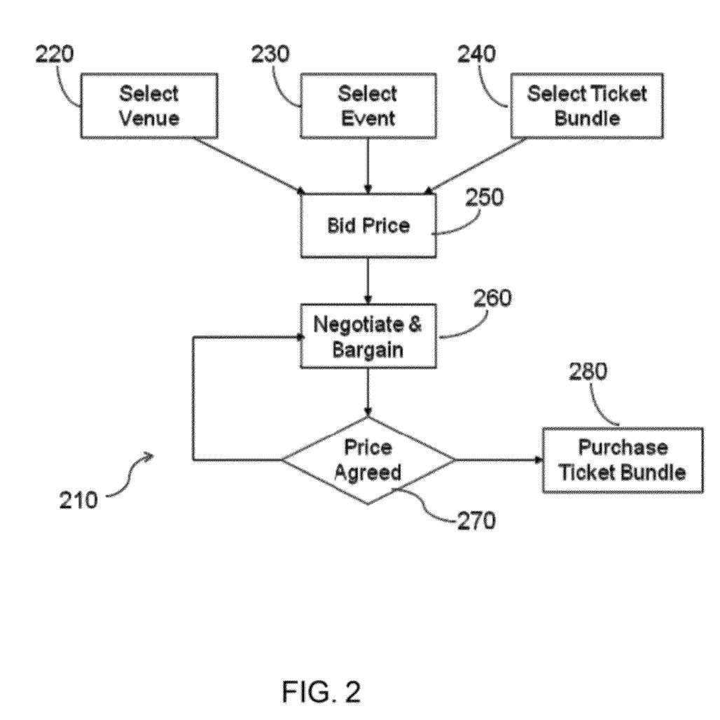

FIG. 2, illustrates a method 210 of vending, hosted in user accessible domain, enabling the customer to select at least one entertainment venue and purchase event's ticket bundle. In this implementation a user will first select the entertainment venue at step 220, select the entertainment event at step 230 and decide what ticket bundle to purchase at step 240. The user will then bid the price or buy it at specified price at step 250. A negotiation step 260 follows the bid step 250. Once the system and user agrees with the purchase price at step 270, the vending method will initiate the purchase process at step 280 and complete the actual purchase transaction. In one embodiment the ticket bundle purchase will be implemented by secured transaction where the user's data will be encrypted before transmitting to the user accessible domain and all the information will be managed with proper security protocol and industry accepted security compliance method.

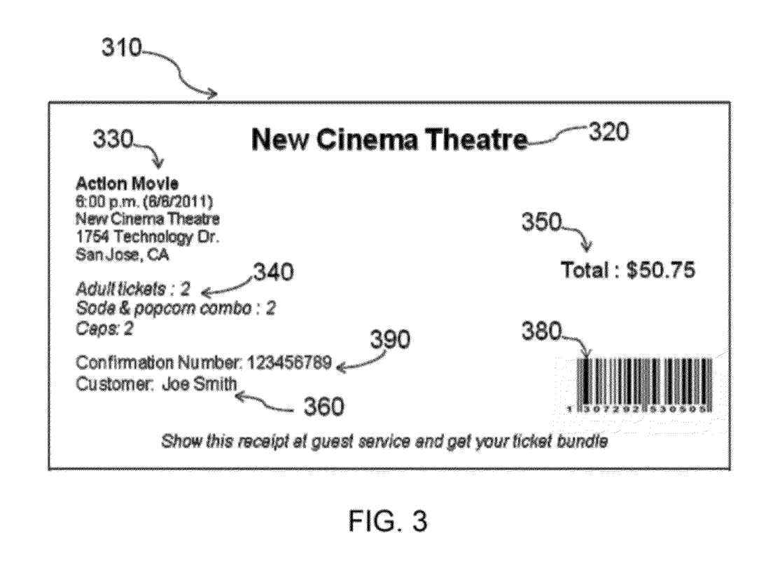

Further in one embodiment FIG. 3 illustrates a typical purchase receipt 310 that is delivered to the customer after successful completion of ticket bundle purchase. It will contain the entertainment venue name 320, the event name and time 330, the ticket bundle information 340, total cost 350 and customer name 360. For purchase validation it will also have a barcode 380 and confirmation number 390 that can be used to redeem the ticket bundle from guest service.

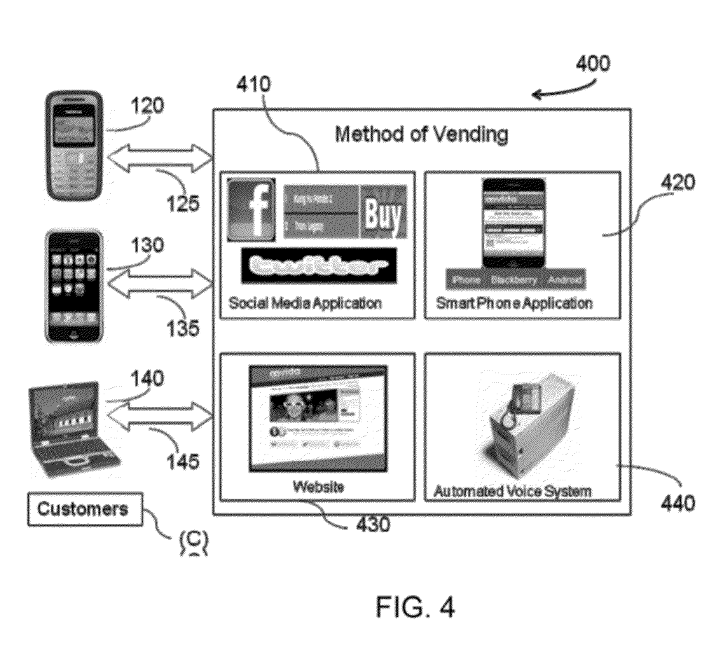

Further in one embodiment FIG. 4 illustrates the multiple application formats 400 for the method of vending, hosted in user accessible domain, enabling the customer to select at least one entertainment venue and purchase event's ticket bundle.

As explained earlier in FIG. 1, the customers (C) have multitudes of devices, including but not limited to, normal phones 120 with text messaging service, smart phones 130 with internet access and systems 140 like laptops, netbooks, tablets, personal computers etc to access method of vending 400 hosted in user accessible domains by step 125, 135, and 145 respectively for real time selection of entertainment venue and event, followed by actual purchase of ticket bundle.

In one embodiment the multitude of social media applications 410 will be implemented that run within a particular social media environment, or platform, and . enables the customer to use the method of vending , hosted in user accessible domain, enabling the customer to select at least one entertainment venue and purchase event's ticket bundle. The customer can use the complete flow and complete ticket bundle purchase without leaving the social media environment.

In another embodiment the multitude of smart phone applications 420 will be implemented that run on different kind of smart phones and enables the customer to use the method of vending , hosted in user accessible domain, enabling the customer to select at least one entertainment venue and purchase event's ticket bundle.

In yet another embodiment the website 430 will be implemented that enables the customer to use the method of vending , hosted in user accessible domain, enabling the customer to select at least one entertainment venue and purchase event's ticket bundle.

In still yet another embodiment, an automated voice system 440 will be installed that will have intelligent information system to guide the users accessing the method of vending by voice. This system will interpret what users are specifying , by voice or pressing touch buttons, and guide them in the process of specifying the venue, event, ticket bundle and complete the purchase.

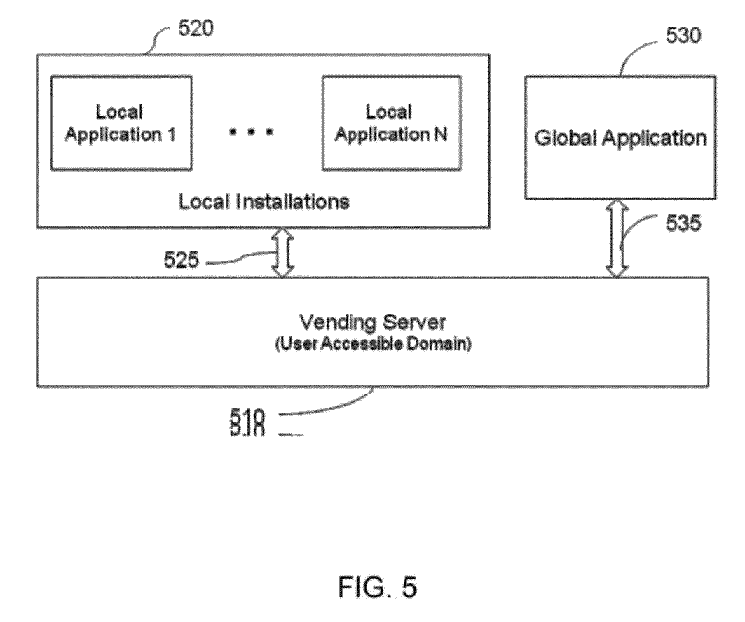

Further in one embodiment FIG. 5 illustrates the local and global implementation of the method of vending, hosted in user accessible domain, enabling the customer to select at least one entertainment venue and purchase event's ticket bundle. The vending server 510 is hosted in user accessible domain and has information about all entertainment businesses, venues, events and ticket bundles. The consumer interface is implemented in two formats—multitudes of local applications 520 and global application 530. The application can be social media application, smart phone application, website or SMS interface.

In one embodiment the local application is catering to a particular entertainment venue or multiple entertainment venues in a particular geographical location. The customer can use these applications and directly purchase the ticket bundles. The entertainment partners can do better local promotion through these applications, understand local customer behavior and vend merchandize accordingly.

In another embodiment the global application has information about the whole country, continent or larger geographical area, and enables the customer to search any entertainment venue or event. The customer can use this single application to search, select and directly purchase the ticket bundles for any entertainment event within the whole country, continent or larger geographical area.

In another embodiment the multitude of local applications 520 and global application 530 interact with vending server 510 to provide data and complete ticket bundle purchase by steps 525 and 535 respectively.

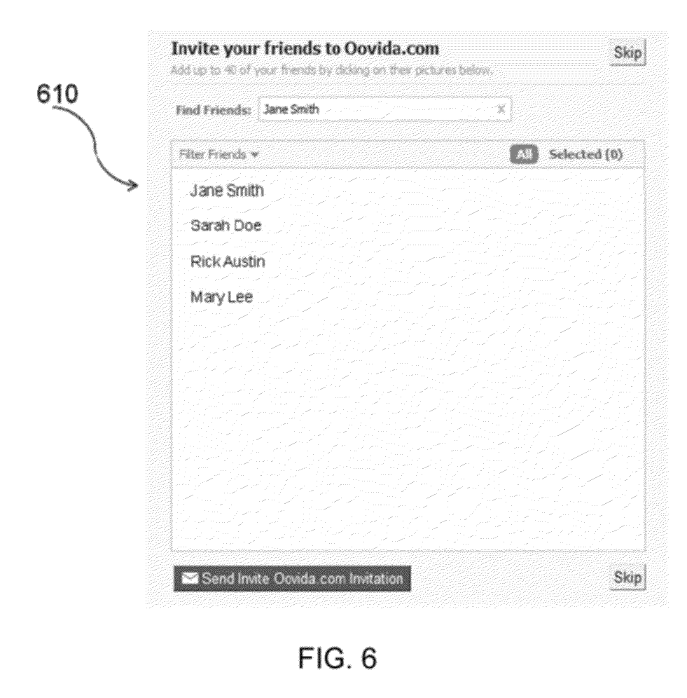

Further in another embodiment FIG. 6 illustrate the application allowing the customer to invite his, or her, friends to join the same entertainment event. The customer can invite friends before or after purchasing the ticket bundle. In social media app the application will automate the friend selection, create invitation message along with entertainment event details and send the invites. The invited friends can then decide to join the entertainment event and purchase the ticket bundle from same vending method. The application will also track how many invited friends are joining the same event and make the entertainment going experience an excellent group experience with friends.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

Within the broad scope and the spirit of a provisional filing, we generally claim:

1. A method of vending, comprising the steps of:
hosting a user accessible domain;
providing said user with an electronic accessible domain to access at least one entertainment venue;
selecting at least one offering for sale that's a combination of two or more venue items;
initiating a payment transaction process in response to said step of selecting;
executing the payment transaction process via secured connectivity; and
obtaining at least one completed transaction code to be shown at said at least one entertainment venue to facilitate an exchange of the at least one completed transaction code in response to the step of selecting at least one offering for sale by said corresponding commercial entity.

2. The method according to claim 1, wherein said entertainment venue is selected from a group of entertainment venues including: a recreational venues, a sporting event venue, a theme park venue, a movie theater venue, a music event venue, and a theatrical event venue.

3. The method according to claim 2, wherein said two or more venue items include any combination of the following: an entrance ticket, a concession item including: a prepared food item, an alcoholic beverage, a non-alcoholic beverage, a candy item, and a snack food item, and an entertainment merchandizing item including: a gift, a souvenir, a CD, a DVD, a book, a magazine, an electronic good, a poster, a toy, a doll, a sporting good, a tee-shirt, a cap, a sports wear item, and a clothing item;
wherein said two or more venue items are for sale by a corresponding commercial entity at an accessed entertainment venue.

4. The method according to claim 3, wherein said two or more venue items include a gift package item comprising: combinations of said entrance tickets, concession items and said merchandizing items.

5. The method according to claim 1, wherein said user accessible domain includes computer accessible websites and mobile device communication applications.

6. The method according to claim 5, wherein said computer accessible websites may be accessed using a plurality of electronic devices, including: desktop computers, laptop computers, net books, electronic communication tablets.

7. The method according to claim 6, wherein said step of providing said user with an electronic accessible domain includes the step of:
using a plurality of connectivity including: a wired Internet connection, a wireless Internet connection, downloading a software application into at least one mobile device using at least one of a plurality of connectivity including: wireless connectivity, Wi-Fi connectivity, and internet connectivity, to access said at least one entertainment venue at the mobile app location.

8. The method according to claim 7, wherein said at least one mobile device includes: a mobile phone device, a smart phone device, a portable computer, a net book, an electronic tablets.

9. The method according to claim 1, wherein said step of obtaining at least one completed transaction code includes the step of:
receiving at least one of a plurality of codes including a one time use only bar codes, a one time use letter, a one time use number or a combination of bar codes, letters, and numbers for a one time use.

10. The method according to claim 1, wherein said step of obtaining at least one completed transaction code includes the step of:
printing a voucher or
getting an appropriate bar-code on a mobile device;
wherein said voucher or said bar-code may be displayed at said at least one entertainment to further facilitate the exchange of the at least one completed transaction code in exchange for tickets and merchandize.

11. The method according to claim 1, wherein said step of initiating includes the steps of:
enabling the user to present an offer price for a user selected offering through a sequence of one or more interactions with a bidding server;
entering said offer price for the user selected offering;
responding to the user with a vendor acceptable price;
declining the vendor acceptable price;
entering another offer price in response to the declined vendor acceptable price; and
repeating said steps of responding, declining and entering until either said bidding server declines a further offer price in response to the declined vendor acceptable price or the user enters an acceptance of the vendor acceptable price.

12. The method according to claim 11, wherein said step of executing the payment transaction process via secured connectivity includes the step of:
completing a payment of the accepted vendor acceptable price.

13. The method according to claim 1 wherein said step of hosting a user accessible domain includes the step of:
hosting a specialized social media site; and
wherein said specialized social media site includes social media sites accessible on the web or via a mobile software application to facilitate presenting the user with a ticket and merchandizing offer sponsored by said specialized social media site.

14. The method of claim 13, wherein said steps of providing, selecting, initiating, executing, and obtaining are all consummated without the user leaving said specialized social media site.

15. The method of claim 13 wherein the user at any time initiates invitation to user's select contacts whose names are either stored in the specialized social media site or manually input to join the user to purchase the same ticket and merchandizing offer sponsored by said specialized social media site.

16. The method of claim 1 wherein the vendor can electronically communicate separately with the user at any time prior or after the said entertainment event to offer additional related or unrelated merchandize including trinkets, toys, souvenirs, pictures, art work, books, magazines, electronic goods, sporting goods, CDs, DVDs, memorabilia, dolls, clothing, shoes, make up items, gift cards, for sale.

17. A method of hosting a user accessible domain which includes the step of
hosting a specialized social media site; and
wherein said specialized social media site includes social media sites accessible on the web or via a mobile software application; and wherein said specialized social media site includes social media sites that are geographically local to user and social media sites that are geographically un-restrained and are global;
storing all relevant entertainment information on a global basis at a single global social media site;
providing all relevant information necessary for the functionality of geographically local social media site from the above global social media site.

18. A system and apparatus to facilitate detailed display of entertainment events and venues that user can access with an electronic device, selecting at least one offering for sale that's a combination of two or more venue items by a corresponding venue, initialization of payment transaction process in response to said step of selecting, execution of the payment transaction process via secured connectivity, and receive at least one completed transaction code to be shown at said at least one entertainment venue to facilitate an exchange of the at least one completed transaction code in response to the step of selecting at least one offering for sale by said corresponding commercial entity, the system comprising:
means for using a plurality of electronic devices, including but not limited to desktop computers, laptops, net books, tablets and using a plurality of connectivity including but not limited to wired or wireless internet connection means for using a plurality of mobile electronic devices including but not limited to mobile phones, smart phones, portable computers, net books, tablets, and using a plurality of connectivity including but not limited to wireless, WiFi, internet connectivity;
means for accessing and connecting the electronic devices using the UI to a Point of Sale system;
means for identifying, selecting and confirming at least one offering for sale by a corresponding commercial entity at an accessed entertainment venue;
means for initiating a payment transaction process in response to said step of selecting;
means for executing the payment transaction process via secured connectivity;
means for obtaining at least one completed transaction code to be shown at said at least one entertainment venue to facilitate an exchange of the at least one completed transaction code in response to the step of selecting at least one offering for sale by said corresponding commercial entity.

19. A system and apparatus according to claim 18, further comprising:
means for hosting a user accessible domain;
means for providing said user with an electronic accessible domain to access at least one entertainment venue;
means for selecting at least one offering for sale that's a combination of two or more venue items;
means for initiating a payment transaction process in response to said step of selecting;
means for executing the payment transaction process via secured connectivity; and
means for obtaining at least one completed transaction code to be shown at said at least one entertainment venue to facilitate an exchange of the at least one completed transaction code in response to the step of selecting at least one offering for sale by said corresponding commercial entity.
